(19) United States
(12) Patent Application Publication
(10) Pub. No.: US 2024/0036908 A1
(43) Pub. Date: Feb. 1, 2024

(54) METHOD AND SYSTEM FOR SUPPORTING MEMORY DEDUPLICATION FOR UNIKERNEL IMAGES

(71) Applicant: NEC LABORATORIES EUROPE GMBH, Heidelberg (DE)

(72) Inventors: Felipe HUICI, Heidelberg (DE); Giuseppe SIRACUSANO, Heidelberg (DE); Davide SANVITO, Heidelberg (DE)

(21) Appl. No.: 18/271,499

(22) PCT Filed: Apr. 21, 2021
(86) PCT No.: PCT/EP2021/060373

§ 371 Date: Jul. 10, 2023

(51) Int. Cl. G06F 9/455

(52) U.S. Cl. CPC G06F 9/45558; G06F 2009/45583

(57) ABSTRACT

A method for supporting memory deduplication for unikernel images includes aligning, by a memory aligner entity, memory pages of unikernel images such that a consistent memory alignment is generated across the unikernel images. A memory deduplication identifier entity generates a unique page identifier for a plurality of memory pages of the unikernel images. The memory deduplication identifier entity matches page identifiers of memory pages for a unikernel image, which is to be loaded into a physical memory, with page identifiers of memory pages that have already been loaded into the physical memory and providing matching information about the matching to a page merger entity. The page merger entity performs page merging based on the matching information provided by the memory deduplication identifier entity.

### CROSS REFERENCE TO RELATED APPLICATIONS

This application is a U.S. National Phase application under 35 U.S.C. § 371 of International Application No. PCT/EP2021/060373, filed on Apr. 21, 2021. The International Application was published in English on Oct. 27, 2022 as WO 2022/223108 A1 under PCT Article 21(2).

### FIELD

The project leading to this application has received funding from the European Union's Horizon 2020 research and innovation programme under grant agreement No 871249.

The present invention relates to a method and system for supporting memory deduplication for unikernel images.

### BACKGROUND

Memory deduplication is a technique for efficiently using physical memory in computer systems. It works by finding sections of equivalent content in virtual memory, and if the contents match (e.g., between two pages of two processes, or two virtual machines), memory deduplication maps those two pages to a single physical memory page, thus reducing the physical memory footprint by half.

Memory deduplication is especially relevant to cloud deployments and virtualization, since many virtual machines (VMs) run concurrently on the same physical machine and are therefore good candidates for deduplication. However, standard VMs are often bloated (large memory footprint, slow boot times, etc.), even though they only need to run a few services (e.g., a web server). To solve this, unikernels, which are highly specialized virtual machine images containing only the code needed to run a particular application, have been proposed.

However, precisely because they are specialized, unikernels break the standard memory deduplication mechanisms. For example, imagine a cloud operator deploying two identical unikernel images, except one of them contains a single additional library needed by its application (see FIG. 1). Because unikernels are custom, they result in a potentially large number of memory pages being different, rendering deduplication ineffective and cancelling some of the effects of specializing the VM image in the first place. In the example illustrated by FIG. 1, inserting a single new library (“uksrand” in unikernel2 on the right-hand side of FIG. 1) causes all memory pages after the first one to be shifted and so to be different from the memory pages from the unikernel1 on the left-hand side of FIG. 1. As a result, memory deduplication can only apply to the first page, i.e. page1 of unikernel1 and unikernel2 illustrated by FIG. 1. This effect applies also to unikernels built to handle Artificial Intelligence (AI) inference workloads.

To make matters worse, state-of-the art memory deduplication daemons, such as KSM (for reference, see https://en.wikipedia.org/wiki/Kernel_same-page_merging), assume that VMs are long-lived, and so take in the order of seconds or tens of seconds to run, analyze the memory pages, and deduplicate them. Unikernel images, in stark contrast, may be quite short lived: in the extreme, they allow for instantiating a service (e.g., a web server such as NGINX, a database such as SQLite, etc.) as the request comes in from the network, replying, and then disappearing once again. In this context, it should be noted that unikernel boot times have been documented to be as low as a few milliseconds (for reference, see “My VM is Lighter (and Safer) than your Container”, SOSP 2017. https://dl.acm.org/doi/10.1145/3132747.3132763). Such short timescales mean that standard, run-time deduplication daemon mechanisms are simply too slow to be practically applicable to unikernels.

### SUMMARY

In an embodiment, the present disclosure provides a method for supporting memory deduplication for unikernel images is provided. The method includes aligning, by a memory aligner entity, memory pages of unikernel images such that a consistent memory alignment is generated across the unikernel images. A memory deduplication identifier entity generates a unique page identifier for a plurality of memory pages of the unikernel images. The memory deduplication identifier entity matches page identifiers of memory pages for a unikernel image, which is to be loaded into a physical memory, with page identifiers of memory pages that have already been loaded into the physical memory and providing matching information about the matching to a page merger entity. The page merger entity performs page merging based on the matching information provided by the memory deduplication identifier entity.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1. is a schematic view illustrating a problematic application scenario for memory deduplication in the context of unikernels, which can be solved by a method or a system according to an embodiment of the present invention;

FIG. 2. is a schematic view illustrating an architecture overview of a method and a system in accordance with embodiments of the present invention; and

FIG. 3. is a schematic view illustrating a method in accordance with embodiments of the present invention.

### DETAILED DESCRIPTION

The project leading to this application has received funding from the European Union's Horizon 2020 research and innovation programme under grant agreement No 871249.

In view of the above, in an embodiment, the present invention improves and further develops a method and a system of the initially described type for supporting memory deduplication for unikernel images in such a way that a more efficient memory deduplication for unikernels is achieved.

In accordance with an embodiment, the present invention provides a method for supporting memory deduplication for unikernel images, the method comprising:
aligning, by a memory aligner entity, memory pages of unikernel images such that a consistent memory alignment is generated across the unikernel images;
generating, by a memory deduplication identifier entity, a unique page identifier for the memory pages of the unikernel images;
matching, by the memory deduplication identifier entity, page identifiers of memory pages for a unikernel image, which is to be loaded into a physical memory, with page identifiers of memory pages that have already been loaded into the physical memory and providing matching information about the matching to a page merger entity;
performing, by the page merger entity, page merging based on the matching information provided by the memory deduplication identifier entity.

Furthermore, in accordance with an embodiment, the present invention provides a system for supporting memory deduplication for unikernel images, the system comprising:
a memory aligner entity that is configured to align memory pages of unikernel images such that a consistent memory alignment is generated across the unikernel images;
a memory deduplication identifier entity that is configured to generate a unique page identifier for the memory pages of the unikernel images, to match page identifiers of memory pages for a unikernel image, which is to be loaded into a physical memory, with page identifiers of memory pages that have already been loaded into the physical memory, and to provide matching information about the matching; and
a page merger entity that is configured to perform page merging based on the matching information provided by the memory deduplication identifier entity.

Memory deduplication is a crucial technique for ensuring efficient use of physical memory in computing systems. However, according to the invention it has first been recognized that state-of-the-art memory deduplication's effectiveness decreases significantly in the presence of specialized virtual machines, i.e. unikernels. More specifically, memory deduplication having slow convergence time in the order of seconds is too slow for just-in-time instantiation use cases. Thus, it has been further recognized that an enormous improvement may be provided by proactively generating a larger number of equal memory pages and by introducing a component that can match in-memory pages to memory pages about to be loaded. To that end, a memory aligner entity aligns memory pages of unikernel images such that a consistent memory alignment is generated across a set of given unikernel images. Then, according to the invention, a unique page identifier is generated for each memory page of the unikernel images. Thereby, a memory deduplication identifier entity can match page identifiers of memory pages for a unikernel image, which is to be loaded into a physical memory, with page identifiers of memory pages that have already been loaded into the physical memory. The memory deduplication identifier entity provides matching information about the matching to a page merger entity, which thereby can efficiently perform page merging based on the matching information.

Thus, the present invention provides a method and a system for supporting memory deduplication for unikernel images, wherein a more efficient memory deduplication for the unikernels is achieved.

The term “unikernel” may refer in particular in the claims, preferably in the description to a specialized virtual machine. For instance, a unikernel can be a specialized virtual machine that contains the components, also known as libraries, needed by a particular application to run, and nothing else, i.e., each unikernel is tailored to an application.

A virtual machine may be a computer file, typically called an image, that behaves like an actual computer. In other words, creating a computer within a computer. It runs in a window, much like any other program, giving the end user the same experience on a virtual machine as they would have on the host operating system itself. The virtual machine is sandboxed from the rest of the system, meaning that the software inside a virtual machine can't escape or tamper with the computer itself. This produces an ideal environment for testing other operating systems including beta releases, accessing virus-infected data, creating operating system backups, and running software or applications on operating systems they weren't originally intended for. Multiple virtual machines can run simultaneously on the same physical computer. For servers, the multiple operating systems run side-by-side with a piece of software called a hypervisor to manage them, while desktop computers typical employ one operating system to run the other operating systems within its program windows. Each virtual machine provides its own virtual hardware, including CPUs, memory, hard drives, network interfaces, and other devices. The virtual hardware is then mapped to the real hardware on the physical machine which saves costs by reducing the need for physical hardware systems along with the associated maintenance costs that go with it, plus reduces power and cooling demand.

The term “memory aligner entity” may be understood, in particular in the claims, preferably in the description as a software functionality that might be implemented as a stand-alone tool or as being a part of the unikernel build system.

The term “memory deduplication identifier entity” may be understood, in particular in the claims, preferably in the description as a software functionality that might be implemented as a stand-alone tool or as being a part of a hypervisor's toolstack (e.g., xl and accompanying libraries in Xen, or QEMU under KVM).

The term “toolstack” may refer to at least one interface for hypervisor management and/or configuration of virtual machines. In particular, the toolstack may comprise a collection of tools and/or libraries, which provide interfaces between the hypervisor and the user/administrator of the system to interact and control the hypervisor. Thus, the toolstack may comprise a number of tools and libraries that are built on top of each other to provide certain functionalities. The toolstack being a collection of tools and libraries may be employed and/or may be configured to handle virtual machine management requests such as requesting, by the toolstack, a builder entity to create a new guest virtual machine/unikernel in response to a user request.

The term “page merger entity” may be understood, in particular in the claims, preferably in the description as a software functionality that might be implemented as a stand-alone tool or as being a part of the Virtual Machine Monitor (VMM, e.g., QEMU).

According to embodiments of the invention, the consistent memory alignment may provide that one or more predetermined unikernel libraries appear at the same memory address in the unikernel images. Thus, memory deduplication for unikernels can be improved.

According to embodiments of the invention, the aligning may comprises that, in a link phase, gaps are introduced between unikernel libraries of a unikernel image in order to generate the consistent memory alignment according to which a predetermined unikernel library appears at a predetermined memory address. Thus, the consistent memory alignment may enable one or more predetermined libraries to appear at the same memory address across several unikernel images. By introducing the gaps between unikernel libraries, a larger number of equal memory pages can be generated across the unikernels images. Thus, an efficient memory deduplication for unikernels can be provided.

According to embodiments of the invention, it may be provided that the memory aligner entity analyses a set of unikernel images in order to derive a set of libraries that are most commonly used. For further improving the memory deduplication, this set of most commonly used libraries may be placed together in the unikernel images. By doing this, the memory aligner entity can reduce the number of gaps in the final aligned unikernel image. For example, it may be provided that a set of libraries common to several unikernels appear together at the beginning of the image without gaps.

According to embodiments of the invention, it may be provided that an array of aligned unikernel images is generated by the memory aligner entity for a predetermined unikernel image, wherein the array represents different memory alignments for the predetermined unikernel. Thus, by having a pool of several extra images for the same unikernel, the efficacy of memory deduplication/merging can be improved, namely, depending on which memory pages are currently loaded in the physical memory. More specifically, this would allow the memory deduplication identifier entity, in a load phase, to decide which unikernel image would be optimal in terms of memory pages already loaded in memory, i.e., in terms of maximizing deduplication.

According to embodiments of the invention, the memory deduplication identifier entity may run through each of the aligned unikernel images of the array in order to choose the one that has the most memory pages in common with the memory pages currently loaded in the physical memory. Thus, the memory deduplication can be improved.

According to embodiments of the invention, it may be provided that, if the unikernel images comprise machine learning (ML) models, the machine learning models of the unikernel images are aligned entirely (i.e., on a per-model basis) or on a per-layer basis in a link phase. Thus, a predetermined machine learning model or a predetermined layer of the machine learning model will appear at the same memory address in the unikernel images. This extends the ability to enhance memory deduplication to trained neural network models present in the unikernel, in particular for unikernels targeting ML inference workloads.

According to embodiments of the invention, it may be provided that generating a unique page identifier includes computing a hash for each memory page by using a hash function. For example, by using the MD5 message-digest algorithm, a MD5 hash may be calculated to generate a unique identifier for each memory page.

According to embodiments of the invention, it may be provided that the generating of page identifiers is performed offline. This would result in much quicker analysis than current state-of-the-art mechanisms such as KSM, since at load/run-time there is only an O(1) match to be performed for each of the memory pages in the unikernel image, which is about to be loaded. In contrast, KSM needs to analyze individual bytes at run-time.

According to embodiments of the invention, the memory deduplication identifier entity may comprise a database of page identifiers for all memory pages that are currently loaded in the physical memory. Thus, an efficient matching can be performed by the memory deduplication identifier entity.

According to embodiments of the invention, the matching information may include a tagging information for each page identifier, wherein the tagging information indicates whether the memory page associated with the page identifier is currently loaded in the physical memory. Thus, based on the matching information, an efficient page merging can be performed by the page merger entity.

According to embodiments of the invention, it may be provided that, based on the matching information, the page merger entity only loads memory pages into the physical memory, which are not already available in the physical memory. With respect to the memory pages that are already loaded into the physical memory, the corresponding page identifiers can be stored and mapped to the memory page that is already available in the physical memory.

According to embodiments of the invention, the page merger entity may inform the memory deduplication identifier entity when a unikernel is destroyed in order to update the memory deduplication identifier's database, which keeps information about the memory pages currently loaded in the physical memory.

According to embodiments of the invention, the page merging may be performed proactively before the unikernel image, which is to be loaded into the physical memory, is booted. Thus, the page merger entity may run when a unikernel instantiation command for the unikernel image, which is to be loaded into the physical memory, is run.

Further features, advantages and embodiments are described and may be become apparent in the following:
Embodiments of the invention may include aligning memory pages in unikernel images in order to improve the efficacy of the memory deduplication.
Embodiments of the invention may include generating multiple images with different alignments in order to further improve the efficacy of memory deduplication depending on which pages are currently loaded in memory.
Embodiments of the invention may align ML models in unikernel images, either entirely or on a per-layer basis (the latter is especially important to e.g., transfer learning).
Embodiments of the invention may generate a unique identifier (e.g., MD5 hash) for each memory page at build time, and store that in a database such that the deduplication analysis at load time is considerably faster than the state of the art, by simply matching the identifiers of the memory pages about to be loaded with those of pages already in memory.

Embodiments of the invention provide a method to deduplicate memory for unikernel images. In this context, it is noted that this procedure may be also applicable to other forms of packaging such as containers.

A method in accordance with an embodiment of the invention may provide the ability to share memory pages between unikernels by using consistent memory alignment across unikernels, and by proactively merging memory pages before boot.

A further embodiment is extended to have the ability to enhance memory deduplication to trained neural network models present in the unikernel, in particular for unikernels targeting ML inference workloads.

Thus, embodiments of the invention may achieve much more efficient deduplication for unikernels with respect to the state of the art such as KSM, since it ensures a much higher presence of similar pages through page alignment/introduction of gaps during the linking stage. In addition, the actual deduplication analysis is much faster, and so applicable to short-lived unikernels. Additionally, embodiments may take into consideration ML models.

Embodiments of the invention may be exploited by a cloud-based product or service that relies on a single application (i.e., a web server, a database back-end, etc.) or set of applications. Further, embodiments of the invention could also be applied to an artificial intelligence inference service.

There are several ways how to design and further develop the teaching of the present invention in an advantageous way. To this end it is to be referred to the dependent claims on the one hand and to the following explanation of further embodiments of the invention by way of example, illustrated by the figure on the other hand. In connection with the explanation of the further embodiments of the invention by the aid of the figure, generally further embodiments and further developments of the teaching will be explained.

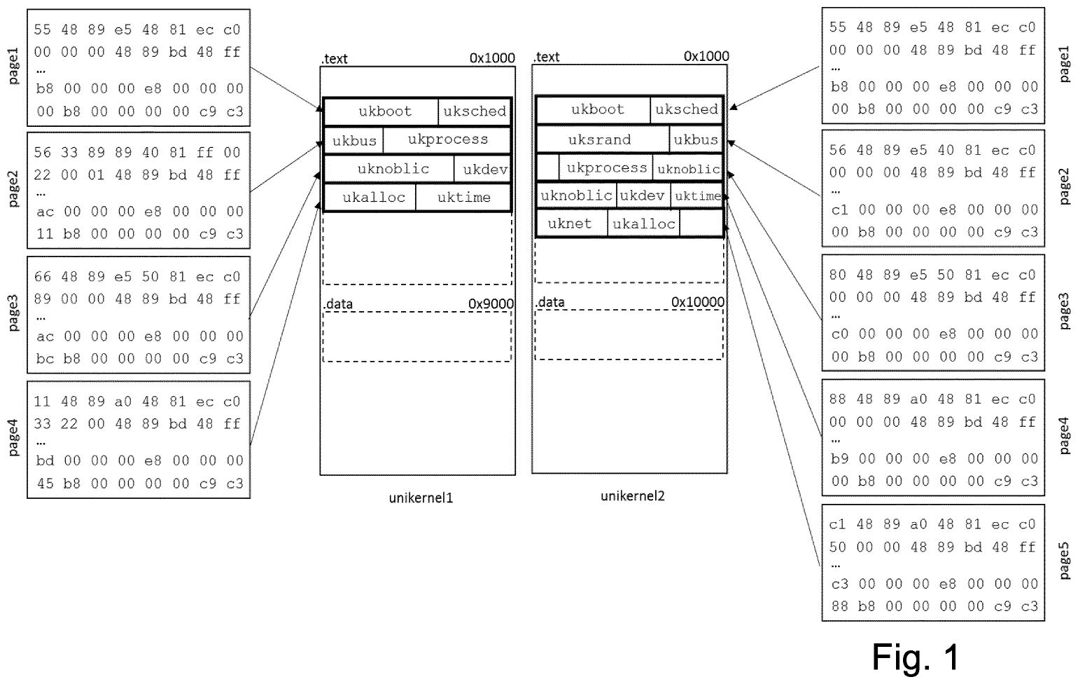

FIG. 1 shows a schematic view illustrating a problematic application scenario for memory deduplication in the context of unikernels, which can be solved by a method or a system according to an embodiment of the present invention. In this context, it is shown that unikernels break standard memory deduplication mechanisms. In the example of FIG. 1 a cloud operator deploys two almost identical unikernel images, where one of them contains a single additional library needed by its application. In the example of FIG. 1, inserting a single new library “uksrand” in unikernel2 causes all memory pages after the first one to be shifted and so to be different from the memory pages from the unikernel1 of FIG. 1. As a result, memory deduplication can only apply to the first page, i.e. page1 of unikernel1 and unikernel2 illustrated by FIG. 1.

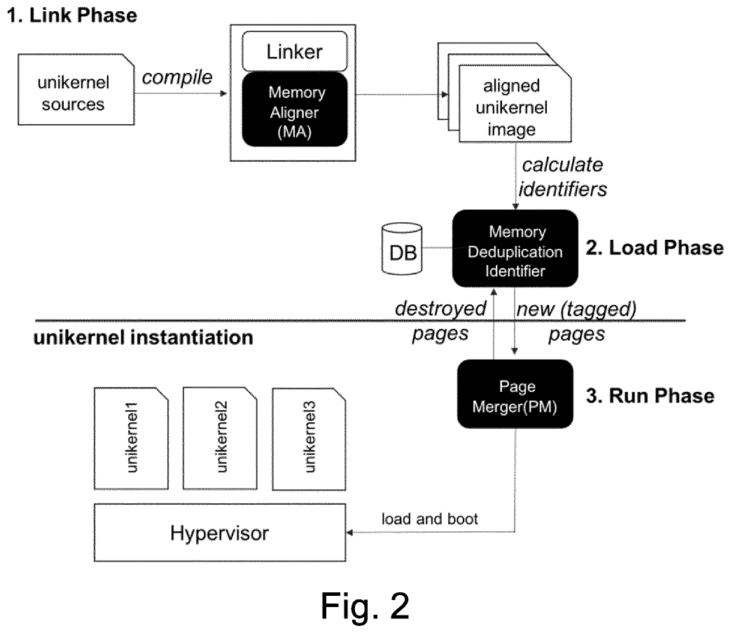

FIG. 2 shows a schematic view illustrating an architecture overview of a method and a system in accordance with embodiments of the present invention. The system may operate in three different phases:
1. A link phase, where a Memory Aligner (MA) ensures that unikernel memory pages, and additionally neural network models, are aligned so that they can be deduplicated.
2. A load phase, where the Memory Deduplication Identifier (MDI) may calculate a unique identifier for each memory page and neural network model, and analyzes if memory pages about to be loaded are already present in the physical memory.
3. A run phase, during which the Page Merger (PM), using matching information from the MDI, performs the memory page merging.
   In the following each of these phases and their corresponding main components (MA, MDI, PM) are described in more detail.

### The Link Phase:

In the link phase, a method and a system in accordance with an embodiment of the invention, through the Memory Aligner (MA), has the high level goal of increasing the number of identical memory pages when given a set of unikernel images to run.

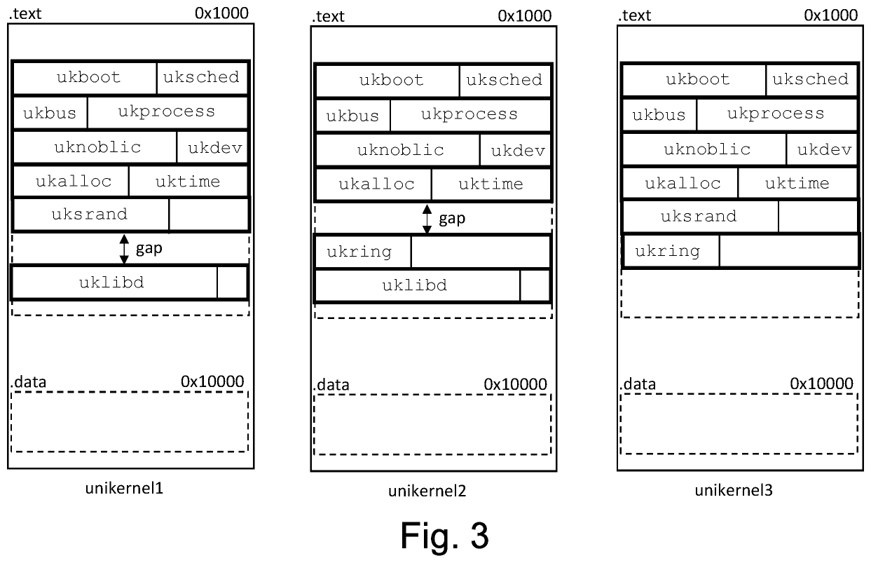

To achieve this, the MA introduces, during a linking process, gaps between the libraries such that a given library A will always appear at a certain memory address. FIG. 3 illustrates this process for three different unikernels (1-3). FIG. 3 shows a schematic view illustrating a method in accordance with embodiments of the present invention, wherein the MA introduces gaps to ensure page similarity. More specifically, in the example of FIG. 3, the MA introduces a gap in unikernel 1 to be able to align the uklibd library with where it appears in unikernel 2. Likewise, the MA introduces a gap in unikernel 2 such that the ukring library can be aligned at the same address in unikernel 3.

As a further enhancement, the MA may analyze a large set of potential unikernels to run, and derive which libraries are the most common among them. The MA can then place these libraries together in the final aligned unikernel image in order to reduce the number of gaps. This is the case in FIG. 3, where libraries common to all three unikernels (e.g., ukboot, uksched, etc.) appear together at the beginning of the image without gaps.

As a further enhancement, the MA may generate, for the same unikernel image, an array of images representing different alignments/gaps. This allows the MDI, in the load phase, to decide which image would be optimal in terms of memory pages already loaded in the physical memory, i.e., in terms of maximizing deduplication.

The MA can be implemented as a stand-alone tool, or as part of the unikernel build system.

### The Load Phase:

When the unikernel image is about to be loaded into the physical memory, but just before it does, the MDI is executed:

First, the MDI analyzes the built image's memory pages and, for each, calculates a hash (e.g., MD5) to generate a unique page identifier for each page. In addition, the MDI keeps a database of all memory pages (i.e., their unique identifiers), which are currently loaded in the physical memory. The MDI then matches the identifiers of the pages of the unikernel image that is about to be loaded with those of the memory pages already in the physical memory and tags the identifiers of the pages of the image about to be loaded with a 1 if the same page is already in memory, or with a 0 otherwise. For instance, this tag might be named SHOULD_DEDUPLICATE. This information will be used in the run phase. It is noted that this matching can be done quickly, in O(1), if implemented via a hash table. This would result in much quicker analysis than known state-of-the-art mechanisms such as KSM, since page identifiers are calculated only off-line, not at run-time.

In this embodiment, at load/run-time there is only an O(1) match performed for each of the memory pages in the image that is about to be loaded. However, individual bytes are not analyzed at run-time as it is the case, e.g., at KSM.

In the case where several versions/images of the same unikernel exist (with different alignments/gaps, see link phase above), the MDI may run through each of them in turn, choosing the one that has the most memory pages in common with those currently loaded in the physical memory.

Whenever a unikernel is destroyed, the page merger (PM) informs the MDI. The MDI uses its database to determine the identifiers for the destroyed unikernel's pages, and removes those from its database (or reduces their counts, since the pages may still be present in other still running unikernels).

Furthermore, Artificial Intelligence (AI) Inference Specialized Images present a great potential for memory deduplication for several reasons:
Libraries supporting model-independent functionalities such as machine learning (ML) model serving will be likely shared across images.
Images serving well-known pre-trained models (e.g. VGG-16 or MobileNet) share the whole set of weights enabling the deduplication also of data-related memory;
Images serving different models trained using Transfer Learning (TL) can still share part of the weights. TL enables the training of a model for a task starting from a model pre-trained on a different one. One approach consists of keeping fixed the weights of almost all the layers and re-training only the last ones. Not only TL highly reduces the training time, but it also offers great opportunities of memory deduplication at inference time even for images serving different models.

Regarding unikernels comprising ML models, embodiments of the invention may provide further additional enhancements as follows:
In this case, the MDI may generate a hash for each trained neural network model (e.g., MobileNet), or even for each separate layer in the model (the latter is especially relevant to models trained via transfer learning, where several models share the majority of the layer weights, with only a few independent layers at the end).
The MDI may detect if the same model is already used with different precision (e.g.: fp16 instead of fp32). If similar code/data is detected the MDI will suggest a modification to the sources in order to use the most common version.

The MDI could be implemented as part of a hypervisor's toolstack (e.g., xl and accompanying libraries in Xen, or QEMU under KVM).

### The Run Phase:

The main component of the run phase is the Page Merger (PM). The PM runs when a command to instantiate a unikernel is run (e.g., in Xen, a “xl create” command). It performs the following functions:
The PM takes the input from the MDI in terms of the memory pages and their SHOULD_DEDUPLICATE tag and only loads the memory pages that have the tag set to 0.
The PM informs the MDI about any destroyed unikernels.

In the case where several versions of the same unikernel are available, the PM will use the unikernel version that has the highest number of SHOULD_DEDUPLICATE tags set to 1, and then proceed as per the bullet points above.

Many modifications and other embodiments of the invention set forth herein will come to mind to the one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for supporting memory deduplication for unikernel images, the method comprising:
aligning, by a memory aligner entity, memory pages of unikernel images such that a consistent memory alignment is generated across the unikernel images;
generating, by a memory deduplication identifier entity, a unique page identifier for a plurality of memory pages of the unikernel images;
matching, by the memory deduplication identifier entity, page identifiers of memory pages for a unikernel image, which is to be loaded into a physical memory, with page identifiers of memory pages that have already been loaded into the physical memory and providing matching information about the matching to a page merger entity;
performing, by the page merger entity, page merging based on the matching information provided by the memory deduplication identifier entity.

2. The method according to claim 1, wherein the consistent memory alignment provides that one or more predetermined unikernel libraries appear at the same memory address in the unikernel images.

3. The method according to claim 1, wherein the aligning comprises that gaps are introduced between unikernel libraries of a unikernel image, such that the consistent memory alignment is generated, wherein a predetermined unikernel library appears at a predetermined memory address.

4. The method according to claim 1, wherein the memory aligner entity analyses a set of unikernel images in order to derive a set of libraries which are most commonly used, and wherein the set of most commonly used libraries are placed together in the unikernel images.

5. The method according to claim 1, wherein an array of aligned unikernel images is generated by the memory aligner entity for a predetermined unikernel image, wherein the array represents different memory alignments for the predetermined unikernel.

6. The method according to claim 5, wherein the memory deduplication identifier entity runs through each of the aligned unikernel images of the array in order to choose the one that has the most memory pages in common with the memory pages currently loaded in the physical memory.

7. The method according to claim 1, wherein in the case that the unikernel images comprise machine learning models, in a link phase, the machine learning models of the unikernel images are aligned entirely or on a per-layer basis, such that a predetermined machine learning model or a predetermined layer of the machine learning model appears at the same memory address in the unikernel images.

8. The method according to claim 1, wherein generating the unique page identifier includes computing a hash for each memory page.

9. The method according to claim 1, wherein the generating of page identifiers is performed offline.

10. The method according to claim 1, wherein the memory deduplication identifier entity comprises a database of the page identifiers for the memory pages that are currently loaded in the physical memory.

11. The method according to claim 1, wherein the matching information includes a tagging information for each page identifier, wherein the tagging information indicates whether the memory page associated with the page identifier is currently loaded in the physical memory.

12. The method according to claim 1, wherein, based on the matching information, the page merger entity only loads memory pages into the physical memory, which are not already available in the physical memory.

13. The method according to claim 1, wherein the page merger entity informs the memory deduplication identifier entity when a unikernel is destroyed in order to update a database associated with the memory deduplication identifier, which keeps information about the memory pages currently loaded in the physical memory.

14. The method according to claim 1, wherein the page merging is performed before the unikernel image, which is to be loaded into the physical memory, is booted.

15. AA system for supporting memory deduplication for unikernel images, the system comprising:
a memory aligner entity that is configured to align memory pages of unikernel images such that a consistent memory alignment is generated across the unikernel images;
a memory deduplication identifier entity that is configured:
to generate a unique page identifier for a plurality of memory pages of the unikernel images,
to match page identifiers of memory pages for a unikernel image, which is to be loaded into a physical memory, with page identifiers of memory pages that have already been loaded into the physical memory, and
to provide matching information about the matching; and
a page merger entity that is configured to perform page merging based on the matching information provided by the memory deduplication identifier entity.

16. The method according to claim 8, wherein the hash for each memory age is generated using a hash function.

17. The method according to claim 16, wherein the hash function is an MD5 message digest algorithm.
